(19) United States
(12) Patent Application Publication
(10) Pub. No.: US 2004/0108738 A1
(43) Pub. Date: Jun. 10, 2004

(54) Forklift clamp and choker softener

(76) Inventor: Marvin C. Marry, Hysham, MT (US)

Correspondence Address: R. Stephen Hansell, Lawyer, Patent Attorney, & Const., 19560 Leo Hansen Road, Florence, MT, 59833-6144, US

(21) Appl. No.: 10/310,218

(22) Filed: Dec. 6, 2002

(51) Int. Cl. B66F 9/12

(52) U.S. Cl. 294/1.1; 414/607; 414/785

(57) ABSTRACT

The present invention provides a novel method to secure and protect slings for lifting and moving odd-shaped or heavy loads suspended from the tine or tines of a conventional forklift truck by means of a clamp designed and sized to fit over the forklift tine and to be located along and secured to the tine by means of a setscrew, said clamp having rounded sides to prevent damage to the sling used to lift the load by the forklift tine or tines, and pins and a removable cover plate to retain the sling on the clamp, and with removable “hairpin” or cotter-type retainer springs to restrain the cover plate.

### REFERENCES CITED

| | | | |
|---|---|---|---|
| 5,887,923 | March 1999 | Gardner | 294/74 |
| 4,493,604 | January 1985 | Walker | 414/622 |
| 4,090,628 | May 1978 | Sinclair | 414/623 |

together with the references cited in the foregoing U.S. Patent documents, as applicable and relevant.

### FIELD OF THE INVENTION

This invention is directed to a clamp or clamps to be attached to a standard forklift tine or tines and method for safely and reliably lifting and moving loads by means of slings attached to the loads.

### BACKGROUND OF THE INVENTION

Odd-shaped, heavy, and cumbersome objects in and around warehouses, construction sites, and docks frequently are moved about by means of a rope, strap, or cable sling connected to, or positioned under, the object (or “load”) being moved and the sling and load are lifted by placing the sling over the tine of a forklift. Sometimes more than one sling is used, and both tines of the forklift sometimes are used to carry the load, either with one sling positioned over both tines, or one or more slings carried by each tine.

While the tines of most forklifts are adjustable to angle the tine(s) slightly upward from rear (near the forklift truck body or frame) to front (the open end(s) of the tine(s)) to hinder slippage of the sling off the front of the tine, it usually is preferable to have the sling(s) positioned somewhat forward on the tine(s) so as to keep the load away from the frame of the forklift and to allow positioning the load during movement and at placement. Essentially, it is friction alone that resists slippage of the sling on the tine. In addition, the tines usually are sufficiently rectangular in cross-section that at least two fairly sharp (90 degree angle with a slight rounded corner) edges of the tine are in contact with the sling. This can result in wear, tearing, cuts, and/or breakage of the sling, a condition aggravated by any damage (nicks, scrapes, cuts) to or roughness in the tine and any movement of the sling along the tine under load.

The present invention provides a solution to the shortcomings of the prior art and conventional practice as described above by providing for a secure clamp which, when affixed to the forklift tine, secures the sling from slipping while providing rounded edges to protect the sling from the cutting, tearing, wear, and breakage against the sharper edges of the bare forklift tine.

### SUMMARY OF THE INVENTION

The present invention embodies a new device and method for transporting loads to be conveniently and/or necessarily lifted by means of a sling as opposed to atop the tines or atop a pallet picked up by the tines of a forklift. The invention consists of heavy plate metal formed and welded into a rectangular tube assembly formed to include a central opening to allow sliding the invention onto and around the forklift tine, with half-round tubing welded to the outboard edges of the rectangular tube to provide a rounded edge for supporting the sling and a setscrew device allowing the invention to be secured by friction of the setscrew and the interior of the rectangular tube against the sides of the tine at the desired location along the tine, with two heavy pins welded to the top edge of the rectangular tube and a removable metal plate having holes to allow the removable metal plate to be placed over the two heavy pins on the top edge of the rectangular tube and secured by means of spring cotter-type pins through holes near the top (open) edges of the two heavy pins. The sling by which the load is to be lifted is placed between the two heavy pins with the spring pins out and the removable metal plate off. The removable metal plate then is positioned over the two heavy pins and lowered to secure the sling in place, and the spring pins are then inserted in the holes of the two heavy pins to keep the sling in place when the sling is not under load. This device and procedure also could enhance safety and save time and labor by enabling the operator of the forklift to secure the sling safely and reliably without assistance from a second workman, helper, or stevedore, and without several additional movements mounting and dismounting the forklift.

### BRIEF DESCRIPTION OF THE DRAWINGS

FIG. 1 is a top view of the assembled invention.

FIG. 2 is an end view showing the open rectangular tube with the half-round half tubing welded to the outside edges and the heavy pins with the removable metal plate and spring pins in place, but with the set screw removed.

FIG. 3 is an isometric view of the assembled invention with the setscrew (a standard Allen-type setscrew in the preferred embodiment, not shown) removed.

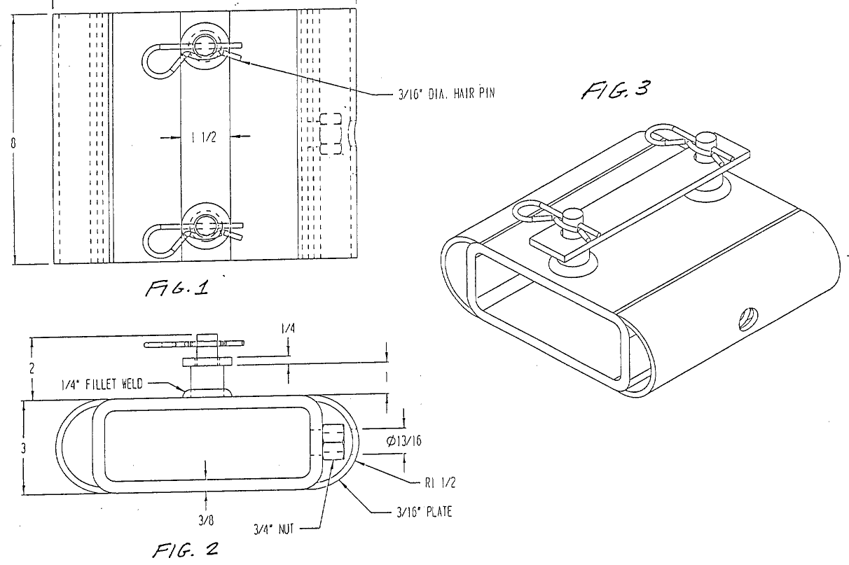

### DESCRIPTION OF THE PREFERRED EMBODIMENT

The invention is directed to a clamp device and method for lifting odd-shaped, heavy, or otherwise cumbersome loads conveniently by means of a rope, cable, or strap sling by a conventional forklift truck. The clamp device permits securing it to the forklift tine in a specific desired position along the tine by means of a set screw, for positively retaining the sling by which the load is to be lifted on the clamp device by means of heavy pins and a metal plate placed over the pins and secured by two (2) spring cotter-type retaining pins, and for preventing damage to the sling from the corners and edges of the bare forklift tines. The preferred embodiment includes the side tubing extending the entire length of the clamp, with one (1) hole accommodating an Allen screw as the setscrew. An earlier iteration of the device had the side tubing extending only across the middle half to two-thirds of the length of the clamp and two (2) set screws of conventional hex head bolts, one near each end of the clamp. This latter style is perfectly acceptable, yet it offers less protection from damage to the setscrew and takes longer to secure than the single screw. The setscrew also could be a threaded lever, to eliminate the need for a separate hand tool to tighten and loosen the setscrew. The latter style also is somewhat more likely to damage the sling than the preferred embodiment.

The preferred embodiment as described and illustrated above includes the present style and preferred use, but is not limited to the preferred embodiment as several similar designs and uses are fully within the intended scope of the invention.

I claim:

1. The clamp device, consisting of a rectangular tube formed from heavy plate steel and approximately ten (10) inches (25.4 centimeters) long, with the interior opening slightly larger than the dimensions of standard forklift tines to permit placing the clamp device over and around the tine and to slide it along the tine length;

2. The clamp device as described in Item 1 above, with side elements welded to the sides of the device to provide a curved lateral edge;

3. The clamp device as described in Items 1 & 2 above, with heavy pins on the top approximately seven (7) inches (18 centimeters) apart and near the openings of the device to permit a strap or sling to be placed over the clamp and between the pins;

4. The clamp device as described at Items 1, 2, & 3 above, with a heavy metal plate bar approximately ten (10) inches long with holes near the ends to permit the bar to be placed over the two heavy pins;

5. The clamp device as described at Items 1, 2, 3 & 4 above, with spring cotter-type retainer pins which can be placed into holes near the top of the heavy pins to secure the bar;

6. The clamp device as described at Items 1, 2, 3, 4, & 5 above, where the side elements described in Item 2 are located in the middle portion of the length of the device to allow two (2) set screws into and through the rectangular tubing near the ends, rather than through a hole in the center of one side element as described at 2 above.

7. The clamp device as described at Items 1, 2, 3, 4, 5, & 6 above, where the materials are any other durable materials and the size, shape, and design are any appropriate equivalent so as to achieve the same objective of securing the sling or similar lifting device to the forklift or similar equipment tine or similar lifting mechanism.
